(19) United States
(12) Patent Application Publication
(10) Pub. No.: US 2003/0146425 A1
(43) Pub. Date: Aug. 7, 2003

(54) Lifting column, preferably for height adjustable furniture, such as beds and tables

(76) Inventors: David Drake, Hertfordshire (GB); Norbert Klinke, Augustenborg (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/240,424

(22) PCT Filed: Mar. 30, 2001
(86) PCT No.: PCT/DK01/00215

(30) Foreign Application Priority Data
Mar. 31, 2000 (DK) PA200000544

(51) Int. Cl. B66D 1/00

(52) U.S. Cl. 254/264

(57) ABSTRACT

A lifting column, preferably for height-adjustable articles of furniture, such as beds and tables, comprises a drive unit (13), wherein extension of the column takes place with at least one flexible element (9), such as a chain, belt or the like running over a pulley wheel. The column comprises two rigidly interconnected pulley wheels (16) and two additional pulley wheels (7) which are arranged such that the four wheels form two pairs and which are rigidly connected with a flexible link in the column. The flexible element runs over each of the two pairs of pulley wheels. One run of the flexible elements between two pulley wheels is fixed to a link in the column, while the other run is fixed to a subsequent link. When the column is subjected to moment loading, the forces will compensate each other fully or partly because of the rigid interconnection between the two sets of pulley wheels (16). The column is hereby very rigid.

The present invention relates to a lifting column, preferably for height-adjustable articles of furniture, such as beds and tables, comprising a drive unit, and wherein extension of the column takes place with at least one flexible element, such as a chain, a toothed belt or the like running over a pulley wheel.

A general way of performing height adjustment of hospital and nursing beds is by using linear actuators in combination with a linkage or scissors mechanism. The actuators satisfy the combination of requirements with respect to strength, reliability in operation and low costs. An example of such a bed is described in EP 488 552 A1 J. Nesbit Evans & Company Limited.

Another way of performing the height adjustment is by using lifting columns, one or two at each end of the bed. Examples of this are described in German Utility Model DE 298 00 015 U1 Joh. Stigegelmeyer GmbH & Co. KG, European Patent Application EP 984 018 A2 Linet Spol SRO, and German Utility Model DE 298 04 283 Dewert Antriebs- und Systemtechnik GmbH & Co. KG.

The strength and rigidity demands on the columns are quite great. In addition to impacts from axial forces, the lifting columns must also be capable of tolerating considerable moment loads, typically because one or more persons are sitting on the edge of the bed. The moment load in the longitudinal direction of the bed is smaller.

German Utility Model DE 297 20 337 U1 Dewert Antriebsund Systemtechnik GmbH & Co. KG discloses a structure based on two strong parallel spindles. This structure has a considerable mounting height.

Mounting below the bed, as is disclosed in the previously mentioned document DE 298 00 015 U1 Stigegelmeyer, requires a very low mounting height. The low mounting height also means that overlap between the individual links in the fully extended state of the column is small, which impairs the stability of the column.

Lifting columns are also used in connection with height adjustable tables. Here, the mounting height is also critical, and in fact the trend is towards using columns with three links. An example of a table column is found in SE 513 249 MPI Teknik AB. Here, too, the problem is lacking rigidity at great moment loads.

In recent years the focus on working environment has involved a shift toward a requirement that working tables, such as writing desks, must generally be height adjustable. This means that the price of the height adjustment is a decisive factor. The efforts of keeping down the price have led to the development of a table type with just one lifting column (monocolumns), which simultaneously provides other advantages. However, this makes great demands on the stability of the lifting column. The lifting column, which is typically positioned at the rear edge of the table, is subjected to great moment loads. Vertical moment loads about a horizontal axis originate from the table top, including the weight of the structure and moveable loads such as a computer and other equipment on the tabletop, personal weight, etc. Horizontal moment loads about a vertical axis are caused by pressure, impacts and bumps against the table edge. As a consequence, the column must be very rigid. Another requirement is that the drive mechanism must be concealed in the column, which must have a nice appearance and be as little voluminous as possible.

The object of the invention is to provide a lifting column of the type stated in the opening paragraph which has a great rigidity, and is simultaneously simple in structure and assembly as well as inexpensive in manufacture.

This is achieved according to the invention in that the lifting column comprises two rigidly interconnected pulley wheels, two additional pulley wheels which are arranged such that the four wheels form two pairs and which are connected with a preferably movable link in the column, and with a flexible element, preferably a chain running over each of the two pairs of pulley wheels, and wherein one run of the flexible elements between two pulley wheels is fixed to one link in the column, while the other run is fixed to a subsequent link. Upon moment loading of the column, the forces will compensate each other fully or partly because of the rigid interconnection of the two sets of pulley wheels. The column is hereby very rigid. At the same time, the column may be simple in structure and assembly as well as relatively inexpensive in manufacture. In addition, the column may be made relatively compact with a low mounting height.

Claims 2-4 define an expedient arrangement of the pulley wheels, which results in easy mounting as well as easy adjustment of the chain tightening. The structure is based on mounting the pulley wheels in an element, which with a shaft portion is arranged in a guide and with a head configured as a bearing bracket for the pulley wheels. The firmly connected pulley wheels are arranged in a fixed position, while the other pulley wheels are longitudinally slidable for tightening of the two flexible elements. It is simple to mount and tighten the chains with an adjustable wedge below the elements.

An embodiment of the column comprises three links, which is particularly suitable where low mounting height and a long stroke are required.

In an embodiment, the drive unit is formed by an electrically driven linear actuator, which is known to be reliable in operation while being sturdy and inexpensive. Further, such an actuator is relatively simple to incorporate in the structure.

In an embodiment, the column is based on two parallel telescopic cylinders, wherein the movable links at the upper end are rigidly interconnected. This results in a particularly rigid structure.

An alternative embodiment is based on mounting the components of the column on profiles having a rigid cross-section, said profiles being then used as a telescopic guide. In this respect, the profiles are expediently based on bent plate members which have a rectangular or substantially rectangular cross-section. The cross-section may be open as well as closed.

In an embodiment the telescopic guides are formed by rail guides. It has been found that ball guides, which are used inter alia in pull-out drawers, are useful. Even though a relatively strong structure must be used, the dimensions are nevertheless modest seen in relation to the column, and the guides have the advantage that they are flat. In a special embodiment, rails guides are used in connection with the above-mentioned profiles with a rectangular cross-section. The rail guides are expediently secured to the sides of the profile that may be adapted to the purpose.

In an embodiment, the column comprises a telescopic jacket which prevents an operator from being injured by touching the movable parts in the column. At the same time the jacket prevents ingress of dirt and moisture into the interior of the column. As regards hospital beds, which are washed in automatic washing machines at 65° C., it is important that moisture cannot penetrate into the interior of the column. The jacket may be made of plastics or sheet metal. Of course, other forms of encapsulations may be used, e.g. a bellows.

In an embodiment, the pulley wheels opposite the position of the drive unit are rigidly connected with a through shaft, which facilitates the positioning of the drive unit inside the column.

In an embodiment, both sets of pulley wheels are rigidly connected, which results in increased rigidity and reduced loading of each of the flexible elements.

In an embodiment, one run of the flexible elements is fixed to the stationary link.

In another embodiment, the other run of the flexible elements is fixed to the outer link.

In an embodiment, each flexible element is formed by two individual subruns, alternatively the flexible element may be endless.

Additional features of the invention appear from the claims and the following explanation with reference to the accompanying drawing. In the drawing:

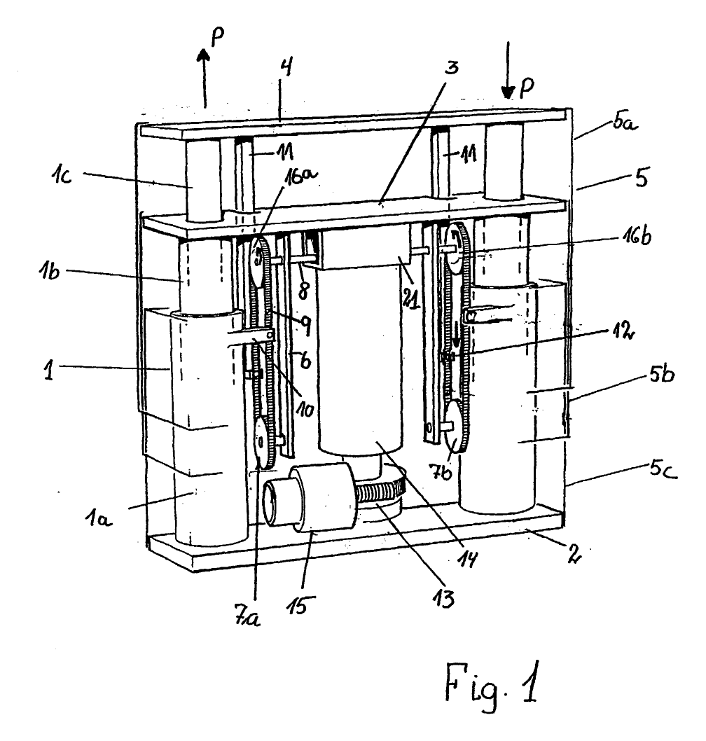

FIG. 1 is a basic sketch of a column according to the invention,

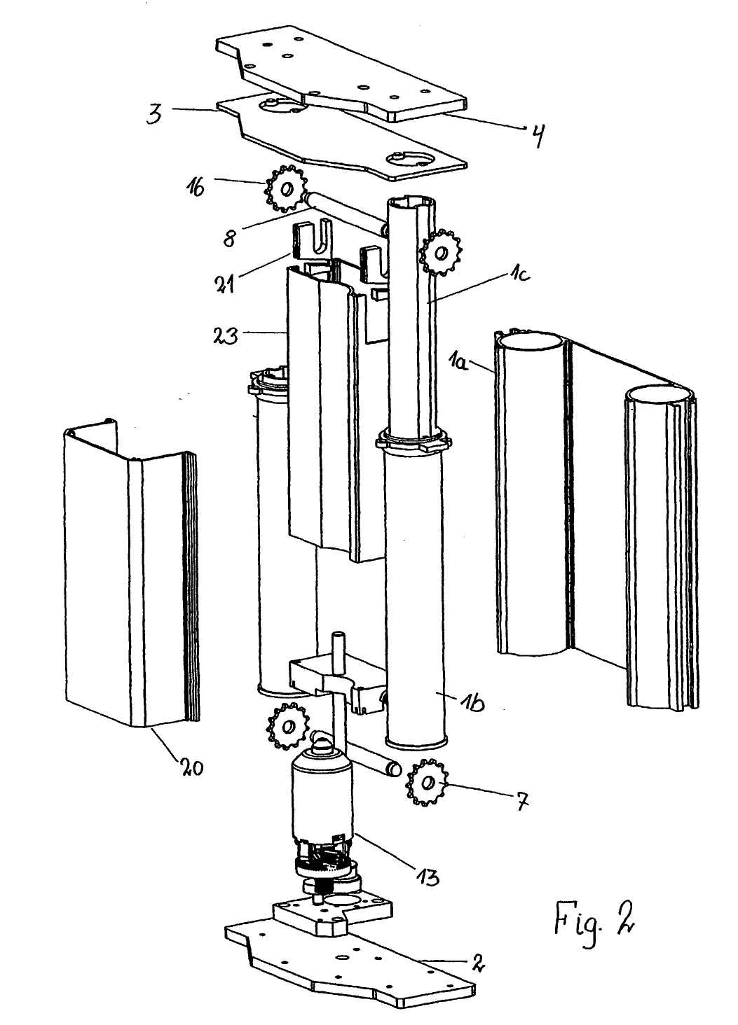

FIG. 2 is an exploded view of a column according to the invention,

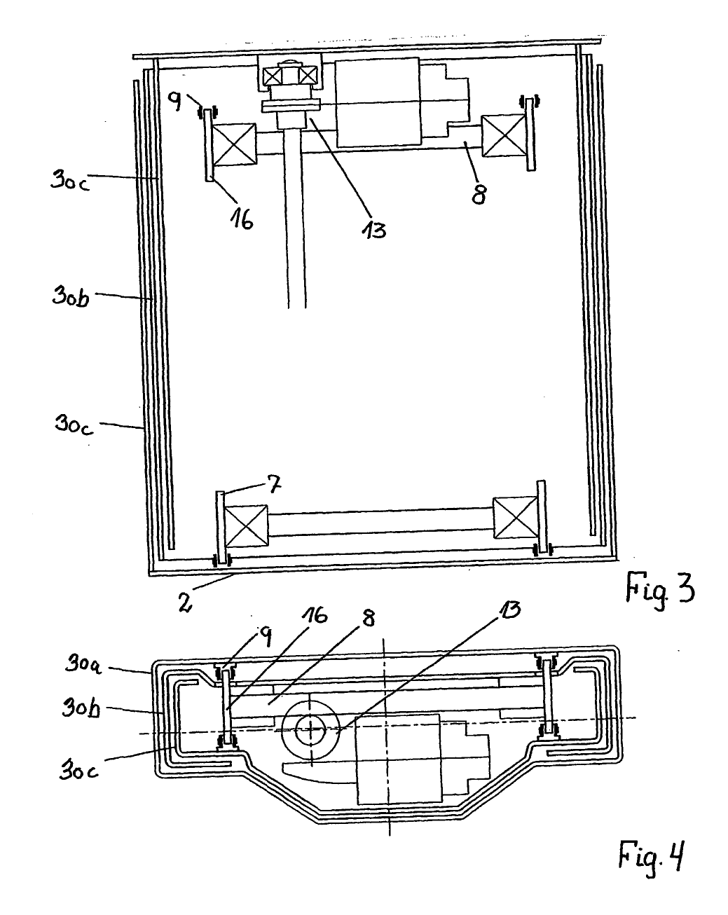

FIG. 3 is basic sketch of another embodiment of the lifting column according to the invention,

FIG. 4 is a top view of the column of FIG. 3.

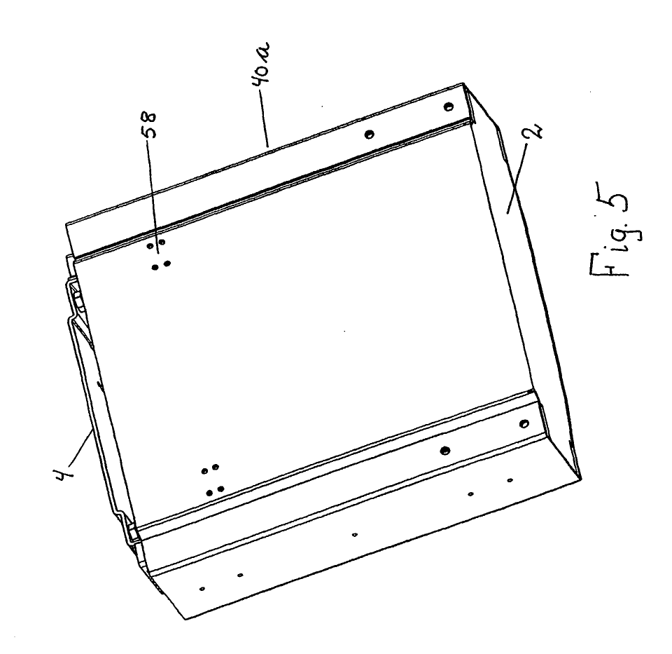

FIG. 5 shows an embodiment of the column according to the principle in FIG. 3, shown in a retracted state and seen from below,

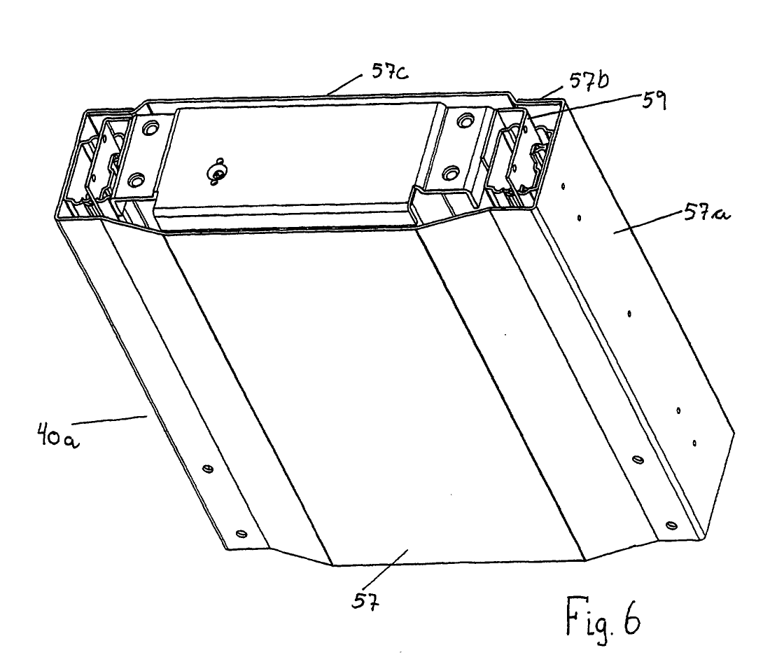

FIG. 6 shows the same as FIG. 5, but seen from above,

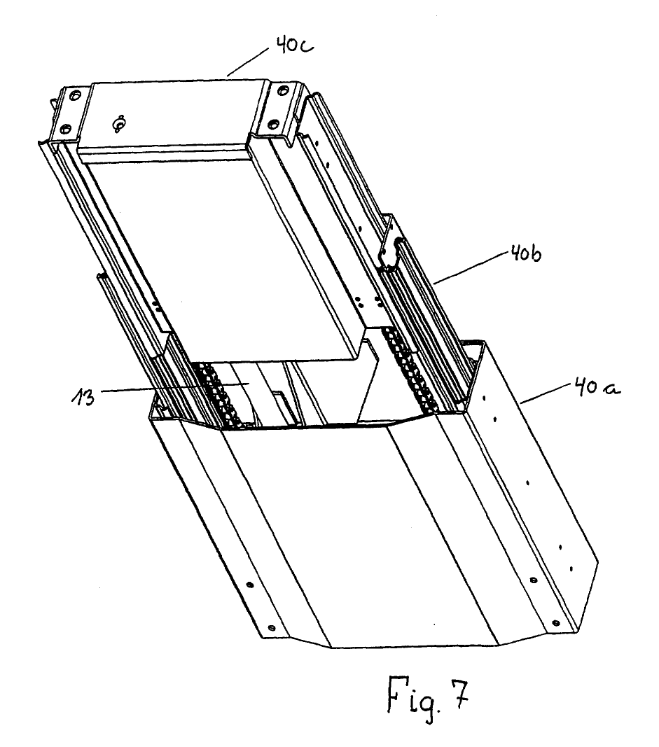

FIG. 7 shows the column of FIG. 5 in a extended state, seen from one side,

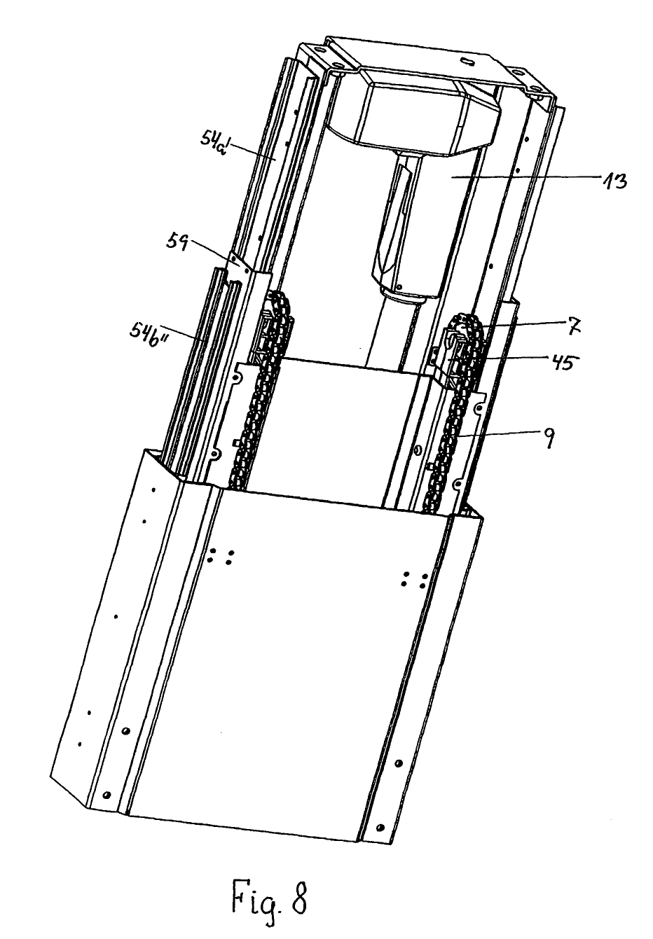

FIG. 8 shows the same as FIG. 7, but seen from the other side,

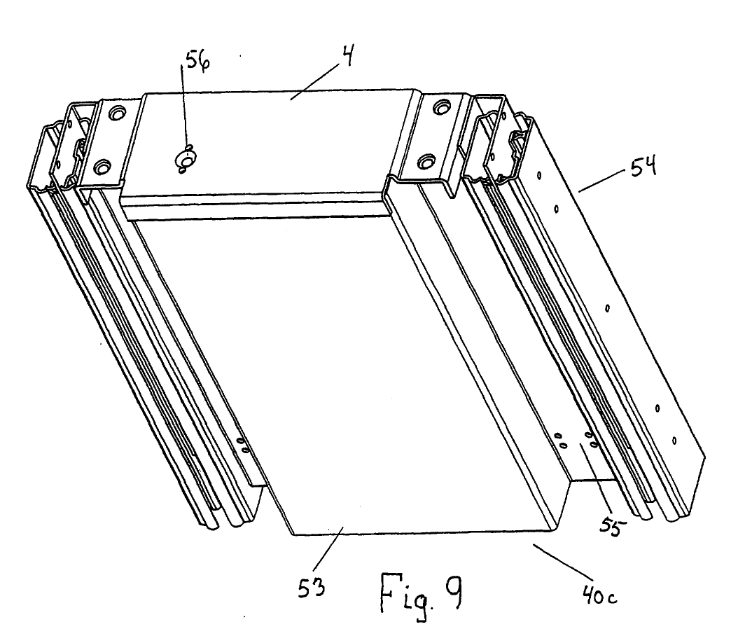

FIG. 9 shows the innermost link in the column of FIG. 5, seen from one side,

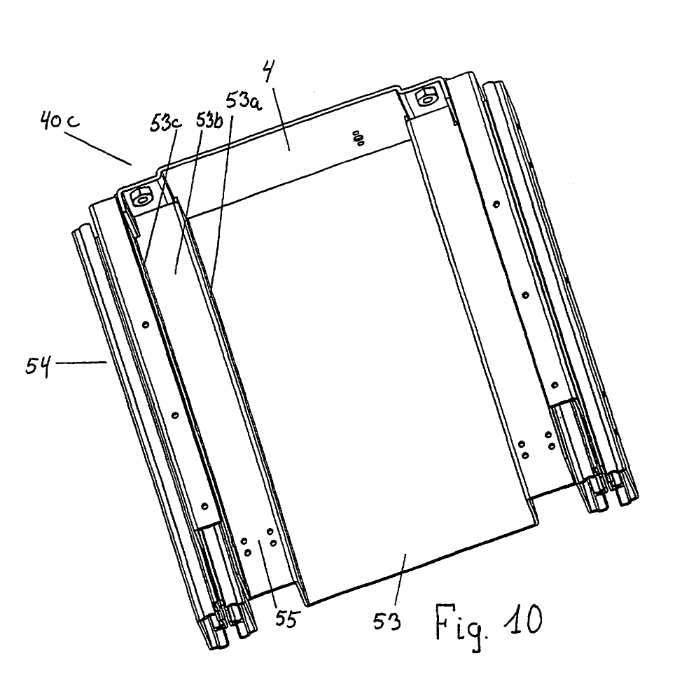

FIG. 10 shows the same as FIG. 9, but seen from the other side,

FIG. 11 shows the intermediate link in the column of FIG. 5, seen from one side,

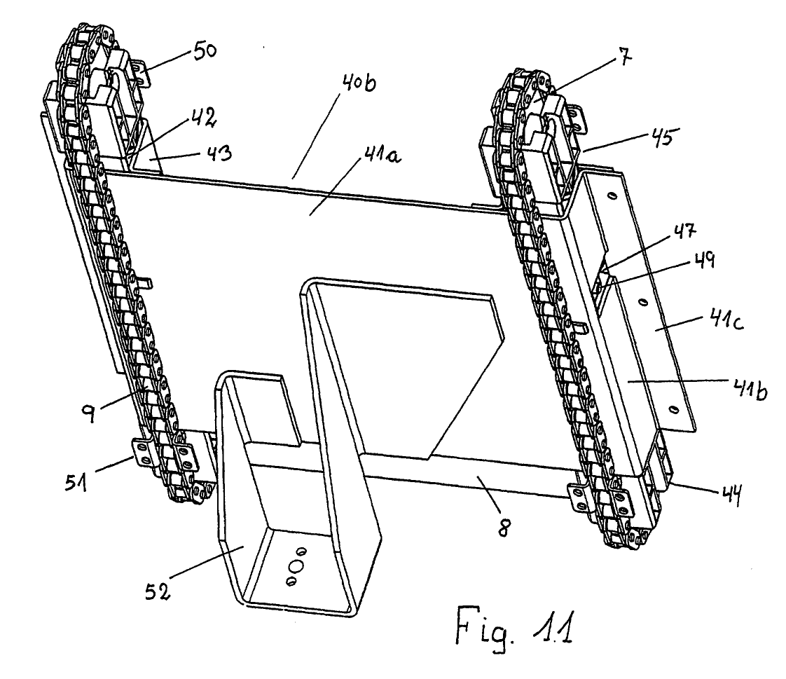

FIG. 12 shows the same as FIG. 11, but seen from the other side,

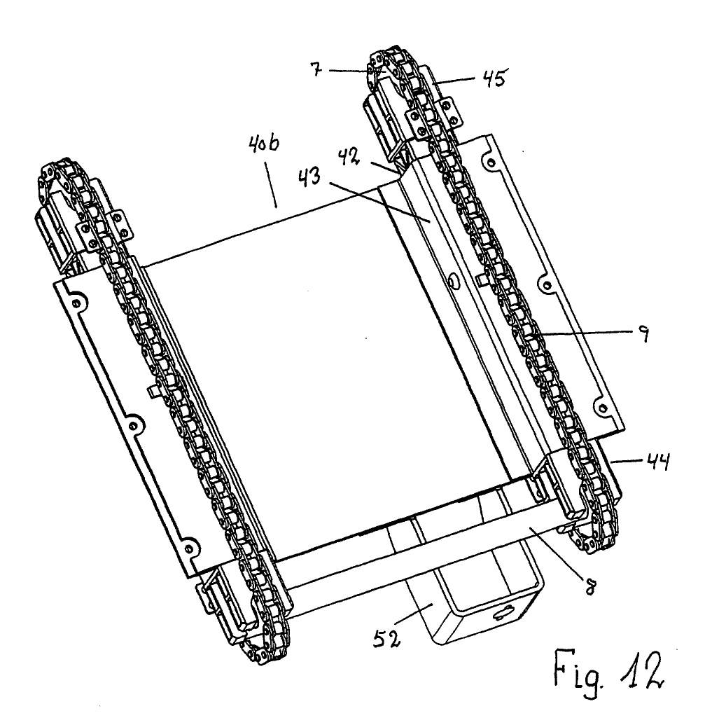

FIG. 13 shows the innermost and the intermediate links in an assembled state,

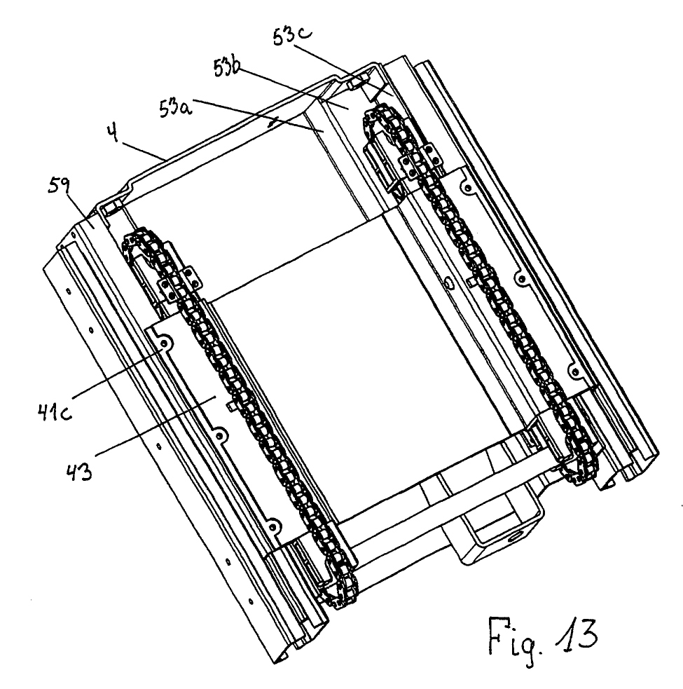

FIG. 14 shows a longitudinal section through one side in FIG. 13, shown with a mounted actuator, and

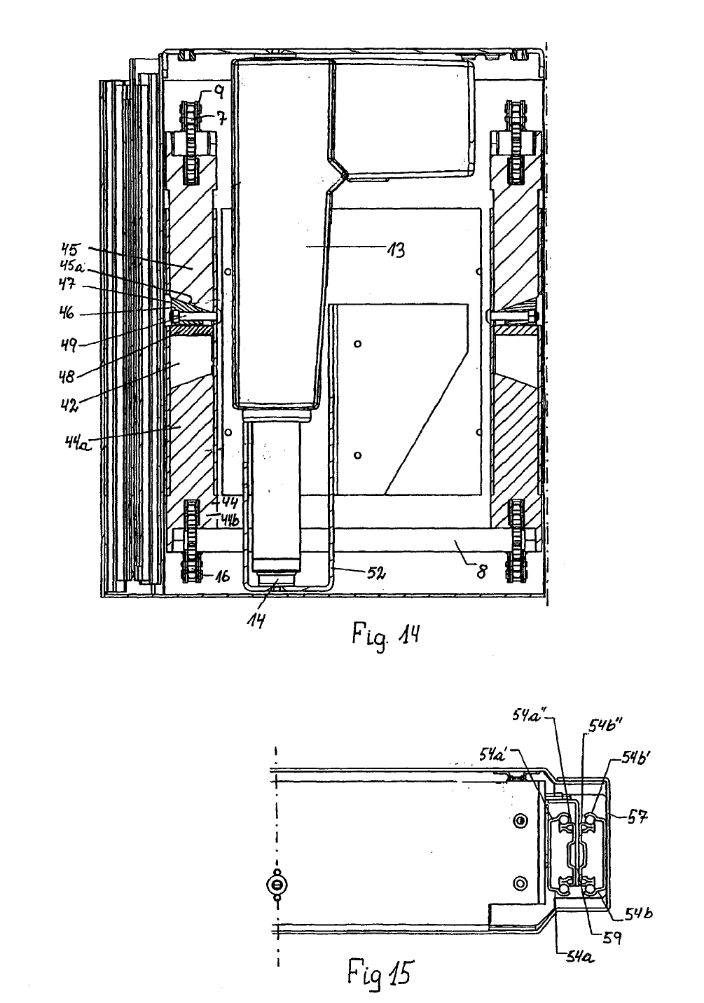

FIG. 15 shows a cross-section through one side in FIG. 13.

The lifting column shown in FIG. 1 comprises two parallel telescopic pipe guides 1 with an outer link 1a, an intermediate link 1b and an inner link 1b. The two pipe guides 1 are secured with the outer link 1a to a bottom member 2.

The two intermediate links 1b are interconnected at their outer ends by a yoke 3, and the two outer links 1c are similarly connected with a yoke 4, which here also forms the top of the column. Both yokes are formed by rigid plate members.

The column as a whole has a telescopic jacket 5 with an outer jacket member 5a secured to the top plate 4, an intermediate jacket member 5b secured to the yoke 3 and an inner jacket member 5c secured to the bottom member. Outwardly, the column thus presents a closed surface. For clarity, the jacket is shown to be transparent so as to make the interior of the column visible.

The column is driven with an electrically driven linear actuator 13 positioned between the bottom member 2 and the yoke 3, with the motor unit 15 secured to the bottom member, and the extension rod 14 secured to the yoke 3.

A hanger 6 in the form of a rod is secured to the underside of the yoke 3 at each side. A pulley wheel 7 is secured at the bottom of the hangers 6, and a corresponding pulley wheel 16 is arranged on a through shaft 8 at the top of the hangers 6. A chain 9 runs over the pulley wheels 7a, 16a; 7b, 16b at each side. The chain 9 is fixed with an arm 10 at the upper end of the outer link 1a on the telescopic cylinders.

The top plate 4 has secured thereto, likewise at each side, a hanger 11 in the form of a flat steel member, to whose lower end the chain 9 is likewise fixed 12.

When the actuator 13 is activated for extension of the extension rod 14, the yoke 3 is raised at the same time, and thereby the outer links 1b in the telescopic cylinders are pulled up too. Since the chain arrangement is suspended from the yoke 3, this will also be moved upwards. This will also cause the chains to be moved. Since the chains are fixed to the upper end of the outer links at 10 on the telescopic cylinders, the chains will pull the hangers 11 on the top plate upwards concurrently with the raising of the upper gear wheels 16. When the top plate 4 is moved upwards, this will also pull the two innermost links 1c in the telescopic cylinders 1 upwards. It will be appreciated that the jacket members 5a, 5b are carried along when the telescopic cylinders are extended.

The extension thus involves a synchronous movement of the two movable links of the telescopic cylinders. This is advantageous in the sense that there is optimal overlap between the links, which is beneficial to the rigidity of the column.

If the column is exclusively subjected to a central axial force, the two chains are uniformly loaded. If the column is subjected to a moment load which e.g. tries to contact the right-hand telescopic cylinder in FIG. 1, then the hanger 11 on the top plate will apply a further downward pull to the chain and thereby try to rotate the upper pulley wheel 16b counter clockwise.

At the left-hand side the moment load will try to pull the telescopic cylinder further out. Because of the rigid shaft 8 to the other pulley wheel 16a at the left-hand side this will also be rotated counter clockwise and thereby exert a pull in the chain run that extends to the fixing 10 on the outermost link 1a, which tries to contract the column in the opposite direction. The two oppositely directed forces lock the column, which will thereby be extremely rigid.

The situation is quite the same if the moment load is reversed, or if the two lower pulley wheels were rigidly connected rather than the upper ones.

FIG. 2 of the drawing shows an embodiment based on extruded aluminium profiles, and where both the upper and the lower gear wheel sets are rigidly connected. The two lower links in the telescopic guide are extruded in one piece with an intermediate member, which forms one side of the column, and a jacket part 20 forms the other side. The two telescopic cylinders form the ends. An intermediate member 23 is provided between the two cylinders. Otherwise, the same reference numerals as in FIG. 1 are used for corresponding parts. It should be noted that 21 indicates a bearing bracket for the upper shaft 8 which connects the upper gear wheels 16.

Another embodiment is shown in FIGS. 3 and 4 of the drawing, comprising three telescopic links. This embodiment differs from the preceding ones in not having two parallel telescopic cylinders. Here, the telescopic links 30a, 30b, 30c themselves form the bearing elements of the structure. Here, the linear actuator is arranged conversely in relation to what is shown in FIGS. 1 and 2, i.e. with the motor part upwards. Otherwise, the same reference numerals as in the foregoing are used for the same elements.

A more concrete example of this embodiment of the column is shown in FIGS. 5-16 and will be explained more fully below. The same reference numerals as in the foregoing are used for the same parts.

The explanation takes its point of departure in FIGS. 11 and 12 which show the intermediate link 40c of the column. This link is based on a plate member 41 with upwardly folded side edges 41a which terminate in a flange 41b. At each side there is a channel 42 formed by securing a Z-shaped plate 43 at the upwardly folded side edge 41a. An element 44 is inserted with a shaft end 44a at one end of each channel 43, said element having a head 44b configured as a bearing bracket for the through shaft 8 and recesses for the toothed wheels 16. A similar element 45 is inserted at the opposite end of the channels 43, a toothed wheel 7 being mounted in the head. As will appear from fig., the end of the element 45 rests with an inclined end face 45c on a wedge element 46 inserted through an opening 47 in the side edge 41b. The wedge element 46 rests on an intermediate bottom 48 in the channel 42. In the wall, opposite the opening, a screw 49 is inserted through a hole into the wedge element 46. The screw extends through a channel in the wedge element 46, in which a nut is mounted. The chain tightening may be adjusted by operation of the screw 49. When the wedge element 46 is pulled into the channel, the element 45 carrying the toothed wheel 7 is pushed outwards, and the chain 9 is tightened. The chain is relaxed by moving the wedge element 46 outwards toward the side opening 47. Mounting brackets 50, 51 in the form of angular brackets are provided on the chain 9 for securing the two other links 40a, 40c. In addition, there is a bracket 52 on the link 40b for securing the end of the extension rod 14 on the actuator 13.

The innermost link 40c is shown in FIGS. 9 and 10. This is likewise based on an upwardly folded plate member 53, which is closed at the top by a top plate 4. The plate member is folded upwards with a stepped side edge consisting of a first sub edge 53b, which merges into a wall part 53b in parallel with the plate and terminates with a second sub edge 53c. A guide 54 is secured on each side of the link. The link 40c is secured to the lowermost chain brackets 51 through the mounting holes 55. The top plate 4 is formed with a set of mounting holes 56 for the mounting of the actuator 13.

The outermost link 40a of the column appears from FIGS. 5-8, and this likewise consists of a plate member 57 with upwardly folded side edges 57a terminated with flaps 57b facing toward each other. The plate member 57 is closed by a side plate 57c secured to the flaps. The link is secured to the uppermost chain brackets 52 via mounting holes 58.

In its retracted state, the column thus appears as a rectangular box, as is shown in FIGS. 5, 6, where the bottom of the outermost link 40a is closed by a bottom plate 2.

The guides 54 are based on two ball guides 54a, 54b of the type which is used for pull-out drawers, cf. FIGS. 15, 6 and 8. Each ball guide consists of two C-shaped rails 54a′, 54a″; 54b′, 54b″ turned with the opening toward each other, and with one inserted into the other, and with grooves for balls formed in the flaps. The outermost ball guide 54b is secured with its one rail 54b′ to the side edge 57a in the outermost link 40a, while the other rail 54b″ is secured to an intermediate member 59 on the intermediate link 40b, viz. to the flap 41c. The other ball guide 54a is secured with its one rail 54a″ to the other side of the intermediate member 59, while its other rail 54a′ is secured to the innermost link 40c on the side edge member 53c.

With reference to FIGS. 7 and 8 the column is shown in its extended position. Activation of the actuator 13 causes the innermost and intermediate links 40c, 40b to be pushed away from each other, thereby also setting the chain 9 in motion. Since the chain is secured 58 at the upper end of the outermost link 40a, the intermediate link 40 will simultaneously be lifted or pushed out of the outer link 40a. When the actuator reverses, i.e. when the activation rod 14 is pulled in, the column retracts.

It should be noted that the plate members, the chain brackets and the ball guides are secured by rivets, which facilitates mounting, but screws or welding may be used of course.

It is contemplated that the outermost link 40a is to form the stationary link, but basically nothing prevents the innermost link 40c form being stationary.

A telescopic cover jacket may be secured to the top of the column, alternatively to the side of the outermost link, as has been described previously and indicated in FIG. 1. It is also possible to secure the individual links of the cover jacket to the respective links in the column, thus providing a consistent withdrawal of the jacket. It is preferred to use a jacket where the uppermost link is the greatest, as shown in FIG. 1. In addition to concealing the gaps between the individual links in the jacket, this also has the advantage that dirt and moisture do not easily penetrate into the column. This is important in particular where the column is used for hospital beds which are washed in washing systems intended for the purpose.

It will be appreciated that, of course, the invention can also to applied to lifting columns with more links or just two links and for other purposes than beds and tables. Just to mention another example, the columns may be used in connection with adjustable chairs. The columns may be used for other purposes than articles of furniture, of course.

1. A lifting column, preferably for height-adjustable articles of furniture, such as beds and tables, comprising a drive unit (13), and wherein extension of the column takes place with at least one flexible element (9), such as a chain, a toothed belt or the like running over a pulley wheel (7, 16), characterized in that it comprises
two rigidly connected pulley wheels (16),
two additional pulley wheels (7) which are arranged such that the four wheels form two pairs (16a, 7a; 16b, 7b) and which are connected with a preferably movable link in the column,
a flexible element (7), preferably a chain running over each of the two pairs of pulley wheels,
and wherein one run of the flexible elements between two pulley wheels is fixed to one link in the column, while the other run is fixed to a subsequent link.

2. A lifting column according to claim 1, characterized in that it comprises an element (44, 45) for each pulley wheel (16, 7), said element comprising a shaft part (44a) arranged in a guide (42) and a head (44b) in which the pulley wheels are mounted.

3. A lifting column according to claim 2, characterized in that at least one element (45) for each chain is longitudinally adjustable for tightening the chains.

4. A lifting column according to claim 3, characterized in that the end (45a) of the element (45) facing into the guide (42) is inclined, and that it cooperates with a wedge (47) resting on a firm support (48), said wedge being adjustable, preferably with an adjusting screw (49) transversely to the element.

5. A lifting column according to claim 1, characterized in that it comprises three links.

6. A lifting column according to claim 1, characterized in that the drive unit is formed by an electrically driven linear actuator (13).

7. A lifting column according to claim 1, characterized in that it comprises two parallel telescopic guides which are rigidly interconnected.

8. A lifting column according to claim 7, characterized in that the telescopic guides are formed by telescopic cylinders (1) which are rigidly connected at both ends.

9. A lifting column according to claim 7, characterized in that the telescopic guides are formed by rail guides (54).

10. A lifting column according to claim 9, characterized in that the telescopic guides are formed by at least two sets of rail guides (54a, 54b), each with two rails, firmly interconnected via a rail (4a″, 54″) in each rail guide.

11. A lifting column according to claim 1, characterized in that the links (40a, 40b, 40c) are based on upwardly bent plate members which have a rectangular or substantially rectangular cross-section.

12. A lifting column according to claim 11, characterized in that a rail guide (54) is provided at each side of the links.

13. A lifting column according to claim 1, characterized in that it comprises a telescopic jacket.

14. A lifting column according to claim 1, characterized in that the pulley wheels (16) arranged opposite the drive unit (13) are rigidly connected with a through shaft (8).

15. A lifting column according to claim 1, characterized in that both sets of pulley wheels are rigidly connected (FIG. 2).

16. A lifting column according to claim 1, characterized in that one run of the flexible elements (9) is fixed to the stationary link (40a).

17. A lifting column according to claim 1, characterized in that the other run of the flexible elements is fixed to the outermost link (40c).

18. A lifting column according to claim 1, characterized in that each individual flexible element (9) is formed by two individual subruns.
